(19) United States
(12) Patent Application Publication
(10) Pub. No.: US 2024/0331698 A1
(43) Pub. Date: Oct. 3, 2024

(54) ELECTRONIC DEVICE AND OPERATION METHOD THEREFOR

(71) Applicant: Samsung Electronics Co., Ltd., Suwon-si (KR)

(72) Inventor: Jaehwan LEE, Suwon-si (KR)

(21) Appl. No.: 18/741,127

(22) Filed: Jun. 12, 2024

Related U.S. Application Data
(63) Continuation of application No. PCT/KR2023/001388, filed on Jan. 31, 2023.

(30) Foreign Application Priority Data
Mar. 15, 2022 (KR) 10-2022-0031941
May 6, 2022 (KR) 10-2022-0055845

(51) Int. Cl. G10L 15/22; G06F 3/01

(52) U.S. Cl. CPC G10L 15/22; G06F 3/013

(57) ABSTRACT

An electronic device is provided. The electronic device includes a communication circuit, memory storing one or more computer programs, and one or more processors communicatively coupled to the communication circuit and the memory, wherein the one or more computer programs include computer-executable instructions that, when executed by the one or more processors individually or collectively, cause the electronic to receive, from an external electronic device, information indicating detection of user's gaze on a specified virtual object displayed on a display of the external electronic device wearable on at least part of a user's body through the communication circuit, receive information from analysis of the user's gaze, receive, from the external electronic device, first information from analysis of the user's face, second information from analysis of a user's gesture, or third information from analysis of whether the user started utterance, corresponding to the point in time at which the user's gaze has been detected, determine a user's intention to utter a voice command based on whether at least one of the first information, the second information, or the third information, and the information from analysis of the user's gaze satisfy a specified condition, execute a voice recognition application stored in the memory upon determining that there is the intention to utter and control the voice recognition application to be in a state of being capable of receiving a voice command of the user.

### CROSS-REFERENCE TO RELATED APPLICATION(S)

This application is a continuation application, claiming priority under § 365 (c), of an International application No. PCT/KR2023/001388, filed on Jan. 31, 2023, which is based on and claims the benefit of a Korean patent application number 10-2022-0031941, filed on Mar. 15, 2022, in the Korean Intellectual Property Office, and of a Korean patent application number 10-2022-0055845, filed on May 6, 2022, in the Korean Intellectual Property Office, the disclosure of each of which is incorporated by reference herein in its entirety.

### BACKGROUND

### 1. Field

The disclosure relates to an electronic device that uses a voice assistant utilizing multi-modality technology and an operation method therefor.

### 2. Description of Related Art

With the emergence of electronic devices, such as augmented reality (AR)/virtual reality (VR) glasses and the emergence of a trend called virtual reality, natural user interfaces, such as gazes, facial expressions, and gestures, which extend from the existing touch interface, are developing into general user interfaces.

In addition, a new interaction model is being developed using multi-modality technology that combines multiple input methods, such as gazes, facial expressions, gestures, or voices.

The above information is presented as background information only to assist with an understanding of the disclosure. No determination has been made, and no assertion is made, as to whether any of the above might be applicable as prior art with regard to the disclosure.

### SUMMARY

To call the voice assistant, a specific keyword, such as “Hi Bixby,” may be uttered, or a touch interface to press an on-screen button or a hardware button may be utilized. When repeated calling is required to use the voice assistant, since the user has to repeatedly press the button or repeatedly utter the specific keyword, such as “Hi Bixby,” there are limitations utilizing the voice assistant in a natural manner.

Aspects of the disclosure are to address at least the above-mentioned problems and/or disadvantages and to provide at least the advantages described below. Accordingly, an aspect of the disclosure is to provide an electronic device capable of using a voice assistant by utilizing natural movements of a user (e.g., gaze, gestures, or facial expressions) in an AR/VR environment and a method of operating the same.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry, memory storing one or more computer programs, and one or more processors communicatively coupled to the communication circuitry and the memory, wherein the one or more computer programs include computer-executable instructions that, when executed by the one or more processors individually or collectively, cause the electronic device to receive from an external electronic device information indicating detection of a user's gaze on a specified virtual object displayed on a display of an external electronic device wearable on at least part of a user's body through the communication circuitry, receive information from analysis of the user's gaze, receive, from the external electronic device, first information from analysis of a user's face, second information from analysis of a user's gesture, or third information from analysis of whether the user started utterance, corresponding to a point in time at which the user's gaze is detected, determine a user's intention to utter a voice command based on whether at least one of the first information, the second information, or the third information, and the information from analysis of the user's gaze satisfy a specified condition, and execute a voice recognition application stored in the memory upon determining that there is the intention to utter and control the voice recognition application to be in a state of being capable of receiving a voice command of the user.

In accordance with another aspect of the disclosure, a method of operating an electronic device is provided. The method includes receiving information indicating detection of user's gaze on a specified virtual object displayed on a display of an external electronic device wearable on at least part of a user's body from the external electronic device through communication circuitry, receiving information from analysis of the user's gaze, receiving, from the external electronic device, first information from analysis of the user's face, second information from analysis of a user's gesture, or third information from analysis of whether the user started utterance, corresponding to a point in time at which user's gaze is detected, determining a user's intention to utter a voice command based on whether at least one of the first information, the second information, or the third information, and the information from analysis of the user's gaze satisfy a specified condition, executing a voice recognition application stored in memory upon determining that there is the intention to utter and controlling the voice recognition application to be in a state of being capable of receiving a voice command of the user.

In accordance with another aspect of the disclosure, one or more non-transitory computer-readable storage media storing computer-executable instructions that, when executed by one or more processors of an electronic device, cause the electronic device to perform operations are provided. The operations include receiving from an external electronic device information indicating detection of a user's gaze on a specified virtual object displayed on a display of the external electronic device wearable on at least part of a user's body through a communication circuitry, receiving information from analysis of the user's gaze, receiving, from the external electronic device, first information from analysis of the user's face, second information from analysis of a user' gesture, or third information from analysis of whether the user started utterance, corresponding to a point in time at which the user's gaze is detected, determining a user's intention to utter a voice command based on whether at least one of the first information, the second information, or the third information, and the information from analysis of the user's gaze satisfy a specified condition, and executing a voice recognition application stored in memory upon determining that there is the intention to utter and controlling the voice recognition application to be in a state of being capable of receiving a voice command of the user.

Another aspect of the disclosure is to provide an electronic device capable of using a voice assistant by utilizing natural movements of a user (e.g., gaze, gestures, or facial expressions) in an AR/VR environment and a method of operating the same.

Another aspect of the disclosure is to use the voice assistant more easily and naturally, and to improve the usability of the voice assistant.

Another aspect of the disclosure is to accurately determine whether a user has the intention to utter a voice command.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a schematic diagram illustrating an electronic device according to an embodiment of the disclosure;

FIG. 3 is a schematic diagram of a method for eye-tracking and display through a transparent member, according to an embodiment of the disclosure;

FIG. 4 is a block diagram of an electronic device according to an embodiment of the disclosure;

FIG. 5 is a block diagram illustrating software modules of the electronic device and an external electronic device according to an embodiment of the disclosure;

FIG. 6 is a block diagram of an utterance start analyzer according to an embodiment of the disclosure;

FIG. 7 is a flowchart showing operations of an electronic device according to an embodiment of the disclosure;

FIG. 8 is a diagram illustrating a user interface provided by an electronic device according to an embodiment of the disclosure;

FIG. 9 is a diagram illustrating the user interface provided by the electronic device according to an embodiment of the disclosure; and

FIG. 10 is a flowchart showing operations of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

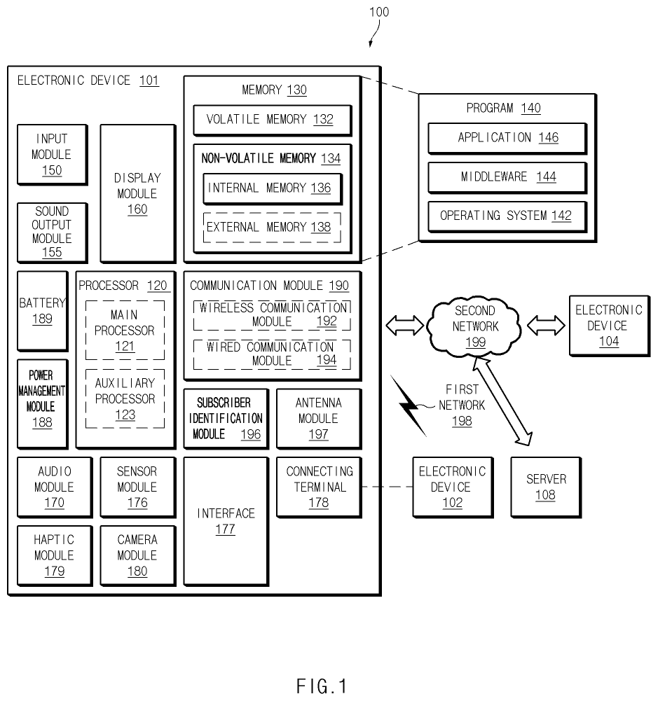

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of external an electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

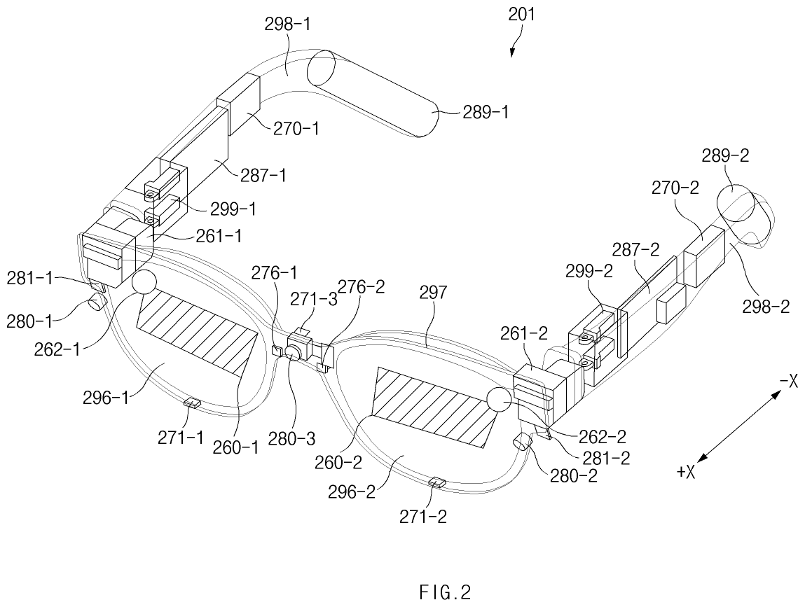

FIG. 2 is a schematic diagram illustrating an electronic device according to an embodiment of the disclosure.

Referring to FIG. 2, in the example of FIG. 2, an electronic device 201 may be referred to as a head-mounted display (HMD) device, a wearable device, smart glasses, or an eyewear. The shape of the electronic device 201 illustrated in FIG. 2 is exemplary, and embodiments of the disclosure are not limited thereto. For example, the electronic device 201 may be any electronic device configured to provide augmented reality (AR) or virtual reality (VR).

According to an embodiment of the disclosure, the electronic device 201 may include at least some of components of the electronic device 101 in FIG. 1. For example, the electronic device 201 may include at least one of a display (e.g., the display module 160 in FIG. 1), a camera (e.g., the camera module 180 in FIG. 1), at least one sensor (e.g., the sensor module 176 in FIG. 1), a processor (e.g., the processor 120 in FIG. 1), a battery (e.g., the battery 189 in FIG. 1), memory (e.g., 130 in FIG. 1), or communication circuitry (e.g., the communication module 190 in FIG. 1). At least some of the components of the electronic device 201 may be located inside the housing of the electronic device 201 or may be exposed to the outside of the housing.

The electronic device 201 may include the display. For example, the electronic device 201 may include a first display 261-1 and/or a second display 261-2. The first display 261-1 and/or the second display 261-2 may include at least one of a liquid crystal display (LCD), a digital mirror device (DMD), a liquid crystal on silicon device (LCoS device), an organic light emitting diode (OLED), or a micro light emitting diode (micro LED). For example, the display of the electronic device 201 may include at least one light source for emitting light. When the first display 261-1 and/or the second display 261-2 includes one of a liquid crystal display device, a digital mirror device, or a liquid crystal on silicon device, the electronic device 201 may include at least one light source for irradiating (a) screen output area(s) 260-1 and/or 260-2 of the display with light. For another example, when the display of the electronic device 201 may generate light by itself, the display may not include a separate light source other than the light source included in the display. If the first display 261-1 and/or the second display 261-2 includes at least one of an organic light emitting diode and a micro LED, the electronic device 201 may provide an image to the user even if it does not include a separate light source. The weight of the electronic device 201 may be reduced by omitting a separate light source when the display is implemented by an organic light emitting diode or a micro LED.

According to an embodiment of the disclosure, the electronic device 201 may include a first transparent member 296-1 and/or a second transparent member 296-2. For example, when the user wears the electronic device 201, the user may see through the first transparent member 296-1 and/or the second transparent member 296-2. The first transparent member 296-1 and/or the second transparent member 296-2 may be formed of at least one of a glass plate, a plastic plate, or a polymer, and may be transparent or translucent. For example, when worn, the first transparent member 296-1 may be disposed to face the user's right eye, and the second transparent member 296-2 may be disposed to face the user's left eye.

According to an embodiment of the disclosure, at least a portion of the first transparent member 296-1 and/or the second transparent member 296-2 may be an optical waveguide. For example, the optical waveguide may transmit an image generated by a display (e.g., the first display 261-1 and/or the second display 261-2) to the user's eyes. The optical waveguide may be formed of glass, plastic, or polymer. For example, the optical waveguide may include a nano-pattern (e.g., a polygonal or curved grating structure) formed inside or on a surface. For example, light incident to one end of the optical waveguide may be propagated inside the optical waveguide by a nano-pattern and provided to the user's eyes. For example, the optical waveguide including a free-form prism may be configured to provide incident light to the user through a reflection mirror.

According to an embodiment of the disclosure, the optical waveguide may include at least one of: at least one diffractive element (e.g., a diffractive optical element (DOE), or a holographic optical element (HOE)) or a reflective element (e.g., a reflective mirror). The optical waveguide may guide the display light emitted from the light source to the user's eyes using at least one diffractive element or the reflective element included in the optical waveguide. For example, the diffractive element may include an input optical member (e.g., 262-1 and/or 262-2) and/or an output optical member (not shown). The first input optical member 262-1 and/or the second input optical member 262-2 may be referred to as an input grating area, and the output optical member (not shown) may be referred to as an output grating area. The input grating area may diffract or reflect light in order to transmit light output from a light source (e.g., the micro LED) to a transparent member (e.g., the first transparent member 296-1 and/or the second transparent member 296-2) of a screen display unit. The output grating area may diffract or reflect the light transmitted to the transparent member (e.g., the first transparent member 296-1 and/or the second transparent member 296-2) of the optical waveguide in the direction toward the user's eyes. For example, the reflective element may include a total reflection optical element or a total reflection waveguide for total internal reflection (TIR). Total reflection may be referred to as one way of guiding light, and may mean making an incident angle so that the input light (e.g., image) through the input grating area is 100% reflected from one surface (e.g., the specific surface) of the optical waveguide and is 100% transmitted to the output grating area. In an embodiment of the disclosure, an optical path of the light emitted from the display may be guided to the optical waveguide by the input optical member. The light moving inside the optical waveguide may be guided toward the user's eyes through the output optical member. The screen output area(s) 260-1 and/or 260-2 may be determined based on light emitted toward the eye direction.

The electronic device 201 has been described as providing an image to the user by using the optical waveguide in FIG. 2, but embodiments of the disclosure are not limited thereto. According to an embodiment of the disclosure, the display of the electronic device 201 may be a transparent or semi-transparent display. In this case, the display may be disposed at a position facing the user's eyes (e.g., the first screen output area 260-1 and/or the second screen output area 260-2).

According to an embodiment of the disclosure, the electronic device 201 may include at least one camera. For example, the electronic device 201 may include a first camera 280-1, a second camera 280-2, and/or a third camera 280-3. For example, the first camera 280-1 and the second camera 280-2 may be used for external image recognition. The first camera 280-1 and the second camera 280-2 may be configured to acquire an image corresponding to a direction (e.g., a +x direction) of the user's gaze. The electronic device 201 may use the first camera 280-1 and the second camera 280-2 to perform head tracking (e.g., 3 degrees of freedom (DoF) or 6 degrees of freedom tracking), hand image detection, hand image tracking, and/or spatial recognition. For example, the first camera 280-1 and the second camera 280-2 may be a global shutter (GS) camera having the same specifications and performance (e.g., the angle of view, shutter speed, resolution, and/or the number of color bits, or the like). The electronic device 201 may support simultaneous localization and mapping (SLAM) technology by performing spatial recognition (e.g., 6-DOF spatial recognition) and/or depth information acquisition using stereo cameras disposed on the right and left. In addition, the electronic device 201 may recognize the user's gesture with stereo cameras disposed on the right and left. The electronic device 201 may detect a faster hand gesture and fine movement by using a GS camera having relatively less distortion than a rolling shutter (RS) camera. For example, the third camera 280-3 may be used for external image recognition. The third camera 280-3 may be configured to acquire an image corresponding to a direction (e.g., the +x direction) of the user's gaze. In one example, the third camera 280-3 may be a camera having a relatively higher resolution than those of the first camera 280-1 and the second camera 280-2. The third camera 280-3 may be referred to as a high resolution (HR) camera or a photo video (PV) camera. The third camera 280-3 may support functions for acquiring a high-quality image, such as auto focus (AF) and/or optical image stabilization (OIS). The third camera 280-3 may be a GS camera or an RS camera.

According to an embodiment of the disclosure, the electronic device 201 may include at least one eye-tracking sensor. For example, the electronic device 201 may include a first eye-tracking sensor 276-1 and a second eye-tracking sensor 276-2. The first eye-tracking sensor 276-1 and the second eye-tracking sensor 276-2 may be, for example, cameras configured to acquire an image in a direction corresponding to the user's eyes. The first eye-tracking sensor 276-1 and the second eye-tracking sensor 276-2 may be configured to acquire the user's right eye image and the user's left eye image, respectively. The electronic device 201 may be configured to detect the user's pupil using the first eye-tracking sensor 276-1 and the second eye-tracking sensor 276-2. The electronic device 201 may acquire the user's gaze from the user's pupil image and provide the image based on the acquired gaze. For example, the electronic device 201 may display the image so that the image is positioned in the direction of the user's gaze. For example, the first eye-tracking sensor 276-1 and the second eye-tracking sensor 276-2 may be a global shutter (GS) camera having the same specifications and performance (e.g., the angle of view, shutter speed, resolution, and/or the number of color bits, or the like).

According to an embodiment of the disclosure, the electronic device 201 may include at least one illumination unit. The illumination unit may include, for example, at least one LED. In FIG. 2, the electronic device 201 may include a first illumination unit 281-1 and a second illumination unit 281-2. The electronic device 201 may, for example, use the first illumination unit 281-1 and the second illumination unit 281-2 to provide auxiliary illumination for the first camera 280-1, the second camera 280-2, and/or the third camera 280-3. In one example, the electronic device 201 may provide illumination for acquiring a pupil image using the illumination unit (not shown). For example, the electronic device 201 may provide illumination to the eye-tracking sensor by using an LED covering an infrared wavelength. In this case, the eye-tracking sensor may include an image sensor for acquiring an infrared wavelength image.

According to an embodiment of the disclosure, the electronic device 201 may include at least one printed circuit board (PCB). For example, the electronic device 201 may include a first PCB 287-1 positioned in the first temple 298-1 and a second PCB 287-2 positioned in a second temple 298-2. The first PCB 287-1 and/or the second PCB 287-2 may be electrically connected to other components of the electronic device 201 through a signal line and/or a flexible PCB (FPCB). For example, the communication circuitry, the memory, at least one sensor, and/or the processor may be disposed on the first PCB 287-1 and/or the second PCB 287-2. For example, each of the first PCB 287-1 and the second PCB 287-2 may be constituted by a plurality of PCBs that are spaced apart by interposers.

According to an embodiment of the disclosure, the electronic device 201 may include at least one battery. For example, the electronic device 201 may include a first battery 289-1 positioned at one end of the first temple 298-1 and a second battery 289 positioned at one end of the second temple 298-2. The first battery 289-1 and the second battery 289-2 may be configured to supply power to components of the electronic device 201.

According to an embodiment of the disclosure, the electronic device 201 may include at least one speaker. For example, the electronic device 201 may include a first speaker 270-1 and a second speaker 270-2. The electronic device 201 may be configured to provide stereo sound by using speakers positioned on the right and left.

According to an embodiment of the disclosure, the electronic device 201 may include at least one microphone. For example, the electronic device 201 may include a first microphone 271-1, a second microphone 271-2, and/or a third microphone 271-3. The first microphone 271-1 may be positioned to the right of a frame 297, the second microphone 271-2 may be positioned to the left of the frame 297, and the third microphone 271-3 may be positioned on a bridge of the frame 297. In one example, the electronic device 201 may perform beamforming by using the first microphone 271-1, the second microphone 271-2, and/or the third microphone 271-3.

According to an embodiment of the disclosure, the electronic device 201 may include the first temple 298-1, the second temple 298-2, and the frame 297. The first temple 298-1, the second temple 298-2, and the frame 297 may be referred to as a housing. The first temple 298-1 may be physically connected to the frame 297 through a first hinge portion 299-1, and may support the frame 297 when worn. The second temple 298-2 may be physically connected to the frame 297 through a second hinge portion 299-2, and may support the frame 297 when worn.

The configuration of the above-described electronic device 201 is exemplary, and embodiments of the disclosure are not limited thereto. For example, the electronic device 201 may not include at least some of the components described with reference to FIG. 2, or may further include components other than the described components. For example, the electronic device 201 may include at least one sensor (e.g., an acceleration sensor, a gyro sensor, and/or a touch sensor) and/or an antenna.

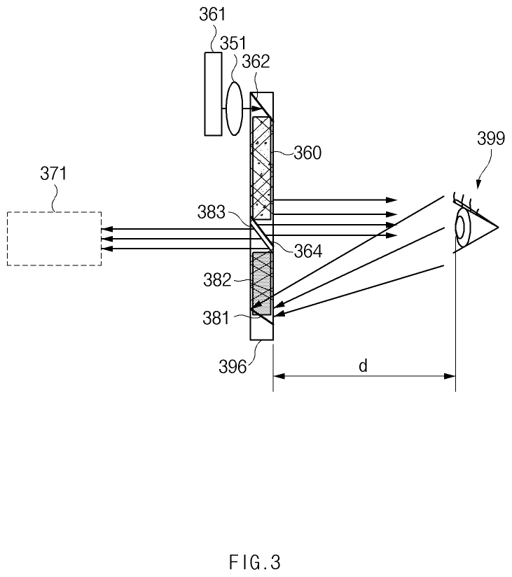

FIG. 3 is a schematic diagram of a method for eye-tracking and display through a transparent member, according to an embodiment of the disclosure.

Referring to FIG. 3, a display 361 (e.g., the first display 261-1 or the second display 261-2 in FIG. 2) may provide an image through a transparent member 396 (e.g., the first transparent member 296-1 or the second transparent member 296-2 in FIG. 2). According to an embodiment of the disclosure, the display 361 may input light corresponding to an image to an input optical member 362 (e.g., the first input optical member 262-1 or the second input optical member 262-2 in FIG. 2) through a lens 351. The input optical member 362 may reflect or diffract the incident light so that the reflected or diffracted light is input into an optical waveguide 360. An output optical member 364 may output the light transmitted through the optical waveguide 360 toward a user's eye 399. In one example, the lens 351 may be included in the display 361. In one example, the position of the lens 351 may be determined based on a distance between the transparent member 396 and the user's eye 399.

An eye-tracking sensor 371 (e.g., the first eye-tracking sensor 276-1 or the second eye-tracking sensor 276-2 of FIG. 2) may acquire an image corresponding to at least a part of the user's eye 399. For example, light corresponding to the image of the user's eye 399 may be reflected and/or diffracted by a first splitter 381 and input to an optical waveguide 382. The light transmitted to a second splitter 383 through the optical waveguide 382 may be reflected and/or diffracted by the second splitter 383 and output toward the eye-tracking sensor 371.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

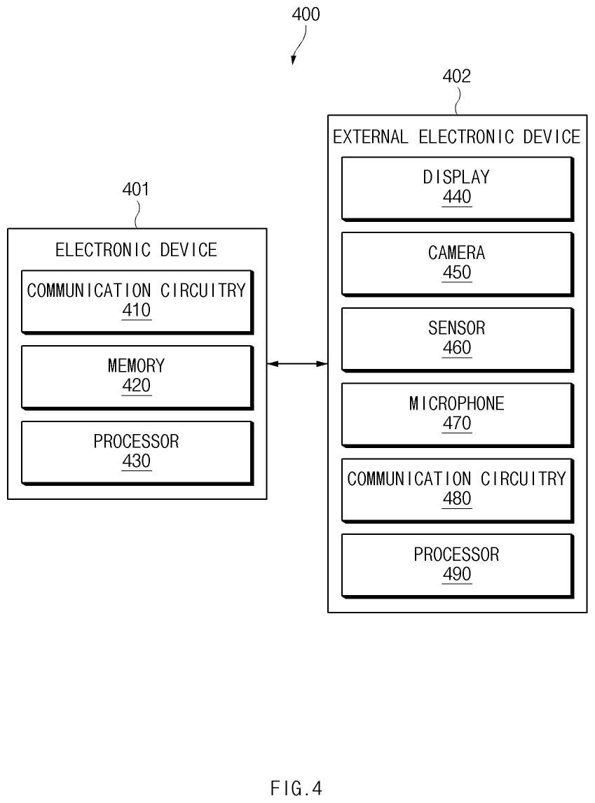

Hereinafter, a configuration and operations of an electronic device and an external electronic device according to an embodiment will be described with reference to FIG. 4.

FIG. 4 is a block diagram 400 of an electronic device and an external electronic device according to an embodiment of the disclosure.

Referring to FIG. 4, according to an embodiment of the disclosure, an electronic device 401 (e.g., the electronic device 101 in FIG. 1) may include communication circuitry 410 (e.g., the communication module 190 in FIG. 1), memory 420 (e.g., the memory 130 in FIG. 1), and a processor 430 (e.g., the processor 120 in FIG. 1). For example, the electronic device 401 may be a portable communication device, such as a smartphone, or a computer device.

According to an embodiment of the disclosure, an external electronic device 402 (e.g., the external electronic device 102 or 104 of FIG. 1, or the electronic device 201 of FIG. 2) may include a display 440 (e.g., the display module 160 in FIG. 1 or the display 261-1 and/or 261-2 in FIG. 2), a camera 450 (e.g., the camera module 180 in FIG. 1 or the camera 280-1, 280-2, and/or 280-3 in FIG. 2, and/or eye tracking sensors 276-1 and 276-2), a sensor 460 (e.g., the sensor module 176 in FIG. 1), a microphone 470 (e.g., the input module 150 in FIG. 1, or the microphone 271-1, 271-2, and/or 271-3 in FIG. 2), communication circuitry 480 (e.g., the communication module 190 in FIG. 1), and a processor 490 (e.g., the processor 120 in FIG. 1). According to an embodiment of the disclosure, the external electronic device 402 may be wearable on at least part of the user's body. For example, the external electronic device 402 may be a head mounted display (HMD) device, such as smart glasses.

According to an embodiment of the disclosure, the external electronic device 402 may provide an augmented reality (AR) or virtual reality (VR) environment. The electronic device 401 may communicate with the external electronic device 402 and control an AR or VR environment provided to the user through the external electronic device 402. The electronic device 401 may provide a voice recognition service to a user experiencing the AR or VR environment through the external electronic device 402. For example, the electronic device 401 may provide the voice recognition service directly or through an external server.

Hereinafter, components of the external electronic device 402 will first be described.

The display 440 of the external electronic device 402 may visually provide information to the user. For example, the display 440 may display images or a graphical user interface. The images or graphic user interface (GUI) displayed on the display 440 may include three dimensional (3D) images or a 3D GUI. The images or GUI displayed on the display 440 may include at least one virtual object. At least one virtual object may include an icon representing an application (or app).

The camera 450 of the external electronic device 402 may include a hand tracking camera, an eye tracking camera, and/or a depth camera. The hand tracking camera may recognize a position and gestures of the user's (or wearer's) hand around the external electronic device 402. The eye tracking camera may track a gaze of the wearer. The depth camera may include, for example, an infrared light emitting diode (LED). The depth camera may provide information making it possible to generate a 3D map of the real space around the external electronic device 402, and use time of flight (ToF) to measure a distance from the external electronic device 402 to a point in the surrounding real space, and estimate a current location of the external electronic device 402.

The sensor 460 of the external electronic device 402 may include an acceleration sensor, a gyro sensor, and/or a geomagnetic sensor. The sensor 460 may measure specific forces, angles, and directions of the user's body. The sensor 460 may estimate a location and a direction of the user based on the measured data.

The microphone 470 of the external electronic device 402 may receive sound (or audio) around the external electronic device 402. For example, the microphone 470 may pick up the voice of a user wearing the external electronic device 402, the voice of a person not wearing the external electronic device 402 around the external electronic device 402, and other ambient sounds.

The communication circuitry 480 of the external electronic device 402 may communicate with the electronic device 401 through a wired or wireless communication network (e.g., the first network 198 or the second network 199 in FIG. 1). For example, the communication circuitry 480 may transmit data and information acquired through the camera 450 or the sensor 460 to the electronic device 401. The communication circuitry 480 may transmit audio data acquired through the microphone 470 to the electronic device 401. As another example, the communication circuitry 480 may receive control signals and/or data from the electronic device 401.

The processor 490 of the external electronic device 402 may be operatively connected to the display 440, the camera 450, the sensor 460, the microphone 470, and the communication circuitry 480. The processor 490 may control the operation and state of the external electronic device 402 by controlling at least one other component of the external electronic device 402 connected to the processor 490.

Although not shown in FIG. 4, the external electronic device 402 may further include other components. For example, the external electronic device 402 may further include a speaker (e.g., the sound output module 155 in FIG. 1) and/or memory (e.g., the memory 130 in FIG. 1). The speaker (not shown) of the external electronic device 402 may output an audio signal (e.g., a voice signal). The memory (not shown) of the external electronic device 402 may store one or more instructions executed by the processor 490 and data processed by the processor 490.

The processor 490 may acquire data of the user's gaze using the camera 450 and analyze the gaze of the user based on the acquired data. For example, the processor 490 may recognize a point corresponding to the user's gaze in the AR or VR environment. For example, when the recognized point corresponds to the location of the specified virtual object displayed on the display 440, the processor 490 may detect that the user is looking at the specified virtual object. The processor 490 may transmit information indicating the detection of the user's gaze on the specified virtual object to the electronic device 401 through the communication circuitry 480. The processor 490 may transmit information from analysis of the user's gaze to the electronic device 401. For example, the information from analysis of the user's gaze may include information on a direction corresponding to the user's gaze and/or the dwell time of the user's gaze. For example, the processor 490 may detect that the dwell time of the user's gaze on the specified virtual object is equal to or longer than a specified time. The processor 490 may transmit information indicating that the user's gaze on the specified virtual object continues for the specified time or longer to the electronic device 401.

The processor 490 may acquire data of the user's face (or facial expression) using the camera 450 and/or the sensor 460, and analyze the face of the user based on the acquired data. The processor 490 may analyze the user's face (or facial expression) based on eye tracking technology and head tracking technology. For example, the processor 490 may analyze the user's face as the user opening their eyes wide, squinting their eyes, or slightly lifting their head. The processor 490 may transmit information from analysis of the user's face to the electronic device 401 through the communication circuitry 480.

The processor 490 may acquire the position and movement data for the hands of the user using the camera 450 and analyze the user's gesture based on the acquired data. The processor 490 may analyze gestures related to the hands of the user based on hand tracking technology. For example, the processor 490 may analyze the gestures of the user as the user touching, tapping, stroking, or holding a specified virtual object displayed on the display 440. The processor 490 may transmit information from analysis of the user's gesture to the electronic device 401 through the communication circuitry 480.

The processor 490 may analyze whether the user started utterance (or whether a voice starts). For example, the processor 490 may determine whether the user started utterance by analyzing the shape and sound of the user's mouth. The processor 490 may analyze the sound received through the microphone 470 and analyze the movement detected through the sensor 460 to determine whether the user started utterance. Herein, the user may refer to a person wearing the external electronic device 402. For example, when an audio signal (e.g., a voice signal) which is equal to or greater than a specified band (e.g., a band of human voices) and a specified magnitude is received through the microphone 470 and a specified movement (e.g., the movement of the external electronic device 402 due to wearer's utterance) is detected by the sensor 460, the processor 490 may determine that the wearer starts uttering. For another example, when an audio signal (e.g., a voice signal) which is equal to or greater than a specified band (e.g., a band of human voices) and a specified magnitude is received through the microphone 470, but a specified movement (e.g., the movement of the external electronic device 402 due to wearer's utterance) is not detected by the sensor 460, the processor 490 may determine that an outsider starts uttering. For still another example, when an audio signal (e.g., voice signal) in which is equal to or greater than a specified band (e.g., a band of human voices) and a specified size is not received, the processor 490 may determine that the received audio signal is noise. The processor 490 may transmit information from analysis of whether the user started utterance to the electronic device 401 through the communication circuitry 480.

Hereinafter, components of the electronic device 401 will be described.

The communication circuitry 410 of the electronic device 401 may communicate with the external electronic device 402 through a wired or wireless communication network (e.g., the first network 198 or the second network 199 in FIG. 1). For example, the communication circuitry 410 may receive, from the external electronic device 402, information about the user's gazes, the user's faces, the user's gestures, and/or whether the user started utterance, which are analyzed by the external electronic device 402 (or the processor 490). The communication circuitry 410 may receive audio data received through the microphone 470 of the external electronic device 402. The audio data may correspond to the user's voice command. According to an embodiment of the disclosure, the user's voice command may not include a wake-up word (e.g., “Hi Bixby”). The user's voice command may include only commands related to functions provided by the electronic device 401 and/or the external electronic device 402. The communication circuitry 410 may transmit control signals and/or data for controlling the external electronic device 402 to the external electronic device 402.

The memory 420 of the electronic device 401 may store data used by at least one component of the electronic device 401 (e.g., the communication circuitry 410 or the processor 430). The memory 420 may store data transmitted and received through the communication circuitry 410. The memory 420 may store one or more instructions executed by the processor 430.

The processor 430 of the electronic device 401 may be operatively connected to the communication circuitry 410 and the memory 420. The processor 430 may control the operation and state of the electronic device 401 by controlling at least one other component of the electronic device 401 connected to the processor 430.

The processor 430 may receive the information from analysis of the user's gaze from the external electronic device 402 through the communication circuitry 410. For example, the processor 430 may receive information indicating that the user's gaze on the specified virtual object displayed on the display 440 of the external electronic device 402 is detected and information indicating that the dwell time of the user's gaze is equal to or longer than a specified time. The specified virtual object may include an icon representing a voice recognition application installed on the electronic device 401. In the disclosure, the voice recognition application may be referred to as a voice assistant application. The electronic device 401 may provide a voice recognition service to the user wearing the external electronic device 402 through the voice recognition application. The processor 430 may determine the user's intention to utter a voice command in response to receiving information indicating that the user's gaze on the specified virtual object is detected from the external electronic device 402.

The processor 430 may receive, from the external electronic device 402 through the communication circuitry 410, information from analysis of the user's gaze, information from analysis of the user's face, information from analysis of the user's gesture, or information from analysis of whether the user started utterance, corresponding to a point in time at which the user's gaze is detected. For example, the processor 430 may receive, from the external electronic device 402 (e.g., the camera 450, the sensor 460, and/or the microphone 470), the analyzed information based on information inputted into the external electronic device 402 within a specified time from the point in time at which the external electronic device 402 detects the user's gaze toward the specified virtual object.

The processor 430 may determine a user's intention to utter a voice command based on the received analyzed information. The processor 430 may determine the user's intention to utter a voice command based on the information from analysis of the user's gaze, the information from analysis of the user's face, the information from analysis of the user's gesture, and the information from analysis of whether the user started utterance, corresponding to the point in time at which the user's gaze is detected. The processor 430 may determine the user's intention to utter a voice command based on whether at least one of the information from analysis of the user's gaze, the information from analysis of the user's face, the information from analysis of the user's gesture, or the information in which from analysis of whether the user started utterance, corresponding to the point in time at which the user's gaze is detected, satisfies a specified condition. For example, the processor 430 may determine that the user has the intention to utter a voice command when the information from analysis of the user's gaze satisfies the specified condition and at least one of the information from analysis of the user's face, the information from analysis of the user's gesture, or the information from analysis of whether the user started utterance satisfies the specified condition. For another example, the processor 430 may determine that the user has no intention to utter a voice command when the information from analysis of the user's gaze does not satisfy the specified condition, or when the first information, the second information, and the third information do not satisfy the specified condition even if the information from analysis of the user's gaze satisfies the specified condition. By further considering the user's facial expressions, the user's gestures, or whether the user started utterance in addition to the user's gaze rather than based on the user's gaze alone, the electronic device 401 may more accurately determine whether the user has the intention to utter a voice command.

The processor 430 may determine that the specified condition is satisfied when the information from analysis of the user's gaze indicates that the dwell time of the user's gaze on a specified virtual object (e.g., an icon representing a voice recognition application) is equal to or longer than a specified time. For example, when the user looks at the specified virtual object for the specified time or longer, the processor 430 may determine that the user has the intention to utter a voice command.

According to an embodiment of the disclosure, the processor 430 may determine that the specified condition is satisfied when information from analysis of the user's face corresponding to the point in time at which the user's gaze is detected indicates a specified facial expression. For example, when the user looks at the specified virtual object for the specified time or longer and makes the specified facial expression, the processor 430 may determine that the user has the intention to utter a voice command. The specified facial expression may be a facial expression learned as a facial expression with the intention to utter by a machine learning algorithm or a facial expression preset by the user as a facial expression with the intention to utter. The specified facial expression may include, for example, widening the eyes, frowning, or slightly lifting the head.

According to an embodiment of the disclosure, the processor 430 may determine that the specified condition is satisfied when information from analysis of the user's gesture corresponding to the point in time at which the user's gaze is detected indicates a gesture for the specified virtual object. For example, when the user looks at the specified virtual object for the specified time or longer and makes a gesture toward the specified virtual object, the processor 430 may determine that the user has the intention to utter a voice command. The gesture for the specified virtual object may include, for example, touching, tapping, stroking, or grasping the specified virtual object.

The processor 430 may determine the user's intention to utter a voice command in different ways depending on the gesture (or type of gesture) for the specified virtual object. For example, in case the gesture of the user corresponding to the point in time at which the user's gaze is detected is a first gesture for the specified virtual object, the processor 430 may determine that the user has the intention to utter a voice command. In case the gesture of the user corresponding to the point in time at which the user's gaze is detected is a second gesture for the specified virtual object, the processor 430 may transmit a request to ask about the intention to utter to the external electronic device 402. In response to receiving the request, the external electronic device 402 may output a question asking the user about intention to utter (e.g., “How can I help you?” or “Do you have something to say?”) in voice or text. The processor 430 may receive the response to the request from the external electronic device 402 and determine the user's intention to utter a voice command based on the received response.

For example, when the processor 430 receives, from the user, the response indicating no intention to utter, such as receiving an answer like “No” or “That's okay” to the question “How can I help you”, or receiving an answer like “Nothing” to the question “Do you have something to say?”, the processor 430 may determine that the user has no intention to utter a voice command. When the processor 430 receives, from the user, the response indicating that there is intention to utter or receives a voice command, such as receiving an answer like “Yes”, or “Do OOO” to the question “How can I help you?” or “Do you have something to say?”, the processor 430 may determine that the user has the intention to utter a voice command.

According to an embodiment of the disclosure, the first gesture is a gesture that is set such that the processor 430 determines that the user has the intention to utter without asking additional questions. The second gesture is a gesture that is set such that the processor 430 asks the user one more question and then determines the intention to utter based on the response to the question. The first gesture may be a gesture in which the user's intention to call the voice recognition application represented by the specified virtual object is clear. For example, the first gesture may be a gesture of tapping the specified virtual object. The second gesture may be a gesture in which the user's intention to call the voice recognition application represented by the specified virtual object is unclear. For example, the second gesture may be a gesture of stroking the specified virtual object. The first gesture may be a gesture learned as a gesture with a clear intention to utter by a machine learning algorithm, or a gesture preset by the user as a gesture with a clear intention to utter. The second gesture may be a gesture other than the learned gesture or the preset gesture.

According to an embodiment of the disclosure, the processor 430 may determine that the specified condition is satisfied when information from analysis of whether the user started utterance corresponding to the point in time at which the user's gaze is detected indicates that the user starts uttering. For example, the user may look at the specified virtual object for the specified time or longer and utter a command without uttering a wake-up word. For example, the user may not be looking at the specified virtual object at the point in time when uttering a command, or after looking at the specified virtual object for the specified time or longer, the user may also utter the command while looking at a different point. When the user starts uttering, the processor 430 may determine that the user has the intention to utter a voice command. Herein, the user may be a user wearing the external electronic device 402. For example, the processor 430 may determine that the specified condition is not satisfied in case information from analysis of whether the user started utterance corresponding to the point in time at which the user's gaze is detected indicates that a user other than the user wearing the external electronic device 402 starts uttering. For another example, the processor 430 may determine that the specified condition is not satisfied in case information from analysis of whether the user started utterance corresponding to the point in time at which the user's gaze is detected indicates that the sound which is inputted into the external electronic device 402 is noise. For example, in case the sound which is inputted into the external electronic device 402 is not an audio signal (e.g., a voice signal) in a specified band (e.g., a band of human voices) or is an audio signal smaller than a specified magnitude even if it is in the specified band (e.g., the band of human voices), the input sound may be analyzed as noise.

The processor 430 may provide a hint for a voice command based on context information related to the user. The context information may include at least one of a usage history of the user for the voice recognition application or the user's gesture. For example, the context information may include a gesture for a virtual object representing an application that supports at least one function. For example, when a user is holding a virtual object representing a gallery application (or another application excluding a voice recognition application) in the AR or VR environment, the processor 430 may receive information indicating that the user is making the above gesture from the external electronic device 402. The processor 430 may receive, from the external electronic device 402, information indicating that the user's gaze on the virtual object representing the voice recognition application is detected in a state in which the user is holding the virtual object representing the gallery application. In this case, the processor 430 may provide a command to execute at least one function supported by the application corresponding to the virtual object held by the user as a hint in a natural language form to the user through the external electronic device 402. For example, in case the application corresponding to the virtual object held by the user is the gallery application, the processor 430 may provide at least one command, such as “larger”, “end”, or “search for photos I took yesterday” in a natural language form. The external electronic device 402 may provide a command in a natural language form to the user through voice or text. After providing the hint, the processor 430 may determine that the user has the intention to utter a voice command regarding the virtual object held by the user when at least one of pieces of information obtained by analyzing the user's face, the user's gesture, or whether the user started utterance corresponding to at a point in time at which the user's gaze on the virtual object representing the voice recognition application is detected satisfies the specified condition.

As another example, the context information may include the usage history of the user for the voice recognition application. For example, the usage history may include information about commands uttered more than a specified frequency, recently uttered commands, and/or commands uttered more than a specified number of times when the user executes the voice recognition application. The processor 430 may provide the commands uttered more than the specified frequency, the recently uttered commands, and/or the commands uttered more than the specified number of times as hints to the user through the external electronic device 402 in a natural language form.

According to an embodiment of the disclosure, the processor 430 may receive, from the external electronic device 402, information indicating that the dwell time of the user's gaze toward a specified virtual object (e.g., the icon representing the voice recognition application) is equal to or longer than the specified time. In case receiving the corresponding information, the processor 430 may transmit a request to ask about the intention to utter to the external electronic device 402. In response to receiving the request, the external electronic device 402 may output a question asking the user about the intention to utter in voice or text. The processor 430 may receive the response to the request from the external electronic device 402 and determine the user's intention to utter a voice command based on the received response.

For example, the processor 430 may ask the user, “Do you have something to say?” through the external electronic device 402. The user may answer “Yes” or “No” to the question. For example, in case receiving the answer of “Yes” from the user through the external electronic device 402, the processor 430 may determine that the user has the intention to utter a voice command. For example, in case receiving the answer of “No” from the user through the external electronic device 402, the processor 430 may determine that the user has no intention to utter a voice command.

For example, the processor 430 may transmit, to the external electronic device 402, the request to ask about the intention to utter in response to receiving information indicating that the dwell time of the user's gaze on the specified virtual object is equal to or longer than the specified time, regardless of whether the information from analysis of the user's face, gesture and analysis of whether the user started utterance, corresponding to the point in time at which the user's gaze is detected, satisfies the specified conditions, and determine the user's intention to utter a voice command according to the response received from the external electronic device 402. For another example, as described above, the processor 430 may determine that the user has the intention to utter a voice command without asking the user about the intention to utter, in response to receiving information indicating that the dwell time of the user's gaze on the specified virtual object is equal to or longer than the specified time, regardless of whether the information from analysis of the user's face, gesture and analysis of whether the user started utterance, corresponding to the point in time at which the user's gaze is detected, satisfies the specified conditions.

As the processor 430 determines that the user has the intention to utter a voice command, the processor 430 may execute the voice recognition application stored in the memory 420. The processor 430 may control the voice recognition application to be in a state of being capable of receiving a user's voice command. For example, the state of being capable of receiving a user's voice command may be referred to as a listening mode.

The processor 430 may receive audio data corresponding to a user's voice input from the external electronic device 402 through the communication circuit 410. The user's voice input may be input through the microphone 470 of the external electronic device 402. The user's voice input may not include a wake-up word. The user's voice input may include only commands related to functions provided by the electronic device 401 and/or the external electronic device 402.

The processor 430 may execute a command corresponding to the voice input through the voice recognition application. For example, the processor 430 may execute the command corresponding to the voice input by converting audio data corresponding to the voice input into text data, determining the user's intention using the converted text data, and executing one or more operations based on the determined user's intention. For another example, the processor 430 may process at least some of the above-described operations through an external server (e.g., an intelligent server). For example, the processor 430 may convert audio data corresponding to the voice input into text data and then transmit the converted text data to the external server through the communication circuitry 410. The processor 430 may receive information about the user's intention and/or one or more operations from the external server and execute one or more operations based on the received information, thereby executing a command corresponding to the voice input.

For example, the processor 430 may transmit an execution result of the command corresponding to the voice input to the external electronic device 402 through the communication circuitry 410 to allow the execution result to be displayed on a display of the external electronic device 402.

When the user's voice input is not received within a specified time after executing the voice recognition application, the processor 430 may terminate execution of the voice recognition application.

The processor 430 may construct and train an intention to utter determination model using analysis information about the user's gaze, the user's face, the user's gesture, and whether the user started utterance, which is received from the external electronic device 402, and information about whether or not the voice recognition application is actually used. Whether or not the voice recognition application is actually used may include at least one of whether or not the user's voice input corresponding to the voice command is received or whether or not the voice command corresponding to the voice input is executed, after the voice recognition application is executed based on the analysis information. For example, in case the user's voice input corresponding to the voice command is received after the voice recognition application is executed or the voice command corresponding to the received user's voice input is executed, the processor 430 may train the model using the analysis information based on the execution of the voice recognition application together with a result value indicating that the user has the intention to utter a voice command. In case the user's voice input corresponding to the voice command is not received after the voice recognition application is executed or the voice command corresponding to the received user's voice input is not executed, the processor 430 may train the model using the analysis information based on the execution of the voice recognition application together with a result value indicating that the user has no intention to utter a voice command.

The processor 430 may determine the intention to utter more precisely by constructing and training the intention to utter determination model, and the more the model is used, the more personalized the model are to the user, allowing the voice recognition application to be utilized more naturally.

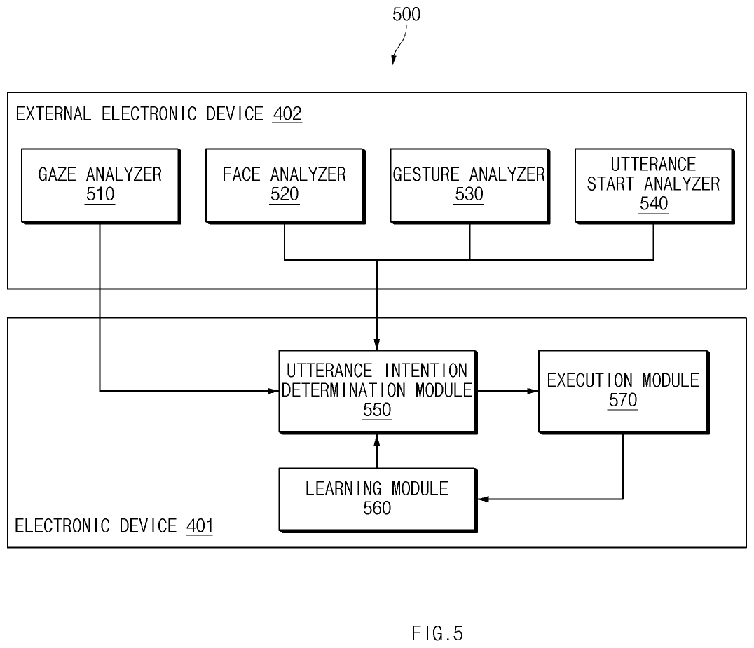

Hereinafter, a system 500 for determining a user's intention to utter a voice command and a method of operating the system 500 will be described with reference to FIG. 5. The system 500 for determining a user's intention to utter a voice command may include the electronic device 401 and the external electronic device 402 in FIG. 4.

FIG. 5 is a block diagram illustrating software modules of the electronic device and the external electronic device according to an embodiment of the disclosure. The software modules of the electronic device and the external electronic device shown in FIG. 5 may be implemented by hardware configurations of the electronic device and the external electronic device shown in FIG. 4.

Referring to FIG. 5, according to an embodiment of the disclosure, the external electronic device 402 may include a gaze analyzer 510, a face analyzer 520, a gesture analyzer 530, and an utterance start analyzer 540.

The gaze analyzer 510 may determine whether or not the user looks at a specified virtual object (e.g., a virtual object representing a voice recognition application). The gaze analyzer 510 may determine the dwell time of the user's gaze on the specified virtual object. The gaze analyzer 510 may determine whether the dwell time of the user's gaze on the specified virtual object is equal to or longer than a specified time. The specified virtual object may be implemented as, for example, an icon or a separate image object.

The face analyzer 520 may recognize the user's facial expression and/or a gesture related to the face based on eye tracking and/or head tracking technology using a camera and/or a sensor mounted on the external electronic device 402. For example, the face analyzer 520 may recognize a gesture in which the size of the user's eyes is expanded or the user slightly lifts the head.

The gesture analyzer 530 may recognize a gesture related to the user's hands based on hand tracking technology using a camera mounted on the external electronic device 402. For example, the gesture analyzer 530 may recognize a gesture in which a user taps a specified virtual object (e.g., the virtual object representing the voice recognition application). For another example, the gesture analyzer 530 may recognize a gesture in which the user holds another virtual object other than the specified virtual object (e.g., the virtual object representing the voice recognition application). The other virtual object other than the specified virtual object (e.g., the virtual object representing the voice recognition application) may be a virtual object representing an application that supports at least one function. The other virtual object may be, for example, a gallery application.

The utterance start analyzer 540 may detect statuses utterance of the user and utterance of an outsider based on voice activity detection (VAD) technology. Herein, the user may refer to a person wearing the external electronic device 402, and the outsider may refer to a person not wearing the external electronic device 402. The utterance start analyzer 540 may detect, from a received audio signal, a specified band of sound (e.g., a band of human voices) and an audio signal (e.g., a voice signal) of a specified magnitude or higher. The utterance start analyzer 540 may determine whether the user is uttering or the outsider is uttering based on whether a specified movement (e.g., movement due to utterance of the wearer) is detected while the voice signal is detected. For example, in case a voice signal is detected and movement due to the utterance of the wearer is detected while the voice signal is detected, the utterance start analyzer 540 may determine that the user starts uttering. In case the voice signal is detected and the movement due to the utterance of the wearer is not detected while the voice signal is detected, the utterance start analyzer 540 may determine that the outsider starts uttering.

The face analyzer 520, the gesture analyzer 530, and the utterance start analyzer 540 may analyze the face, the gesture, and the utterance start status of the user, respectively, based on information input within a specified time from a point in time at which the user's gaze on a specified virtual object (e.g., the virtual object representing the voice recognition application) is detected by the gaze analyzer 510.

Each of the gaze analyzer 510, the face analyzer 520, the gesture analyzer 530, and the utterance start analyzer 540 of the external electronic device 402 may transmit analysis information to the electronic device 401.

According to an embodiment of the disclosure, the electronic device 401 may include an intention to utter determination module 550, a learning module 560, and an execution module 570. The intention to utter determination module 550 may receive analysis information from each of the gaze analyzer 510, the face analyzer 520, the gesture analyzer 530, and the utterance start analyzer 540 of the external electronic device 402. The intention to utter determination module 550 may initially determine a user's intention to utter a voice command based on the fact that the user is looking at the specified virtual object (e.g., the virtual object representing the voice recognition application) according to the analysis information received from the gaze analyzer 510. The intention to utter determination module 550 may initially determine that the user has the intention to utter a voice command in case the user is looking at the specified virtual object (e.g., the virtual object representing the voice recognition application). For example, the intention to utter determination module 550 may determine that the user has the intention to utter a voice command in case the user looks at the specified virtual object representing the voice recognition application for the specified time or longer, execute the voice recognition application, and control the voice recognition application to be in the state of being capable of receiving the user's voice command (e.g., the listening mode).

The intention to utter determination module 550 may finally determine the user's intention to utter a voice command based on whether at least one of the analysis information received from the face analyzer 520, the gesture analyzer 530, and the utterance start analyzer 540 satisfies a specified condition. The intention to utter determination module 550 may finally determine that the user has the intention to utter a voice command when at least one of the analysis information received from the face analyzer 520, the gesture analyzer 530, and the utterance start analyzer 540 satisfies the specified condition.

In case the analysis information received from the face analyzer 520 indicates that the user has a specified facial expression, the intention to utter determination module 550 may determine that the specified condition is satisfied. For example, in case analysis information indicating that the user opens his or her eyes wide, squints his or her eyes, or slightly lifts his or her head is received from the face analyzer 520, the intention to utter determination module 550 may determine that the analysis information received from the face analyzer 520 satisfies the specified condition.

The intention to utter determination module 550 may determine that the specified condition is satisfied in case the analysis information received from the gesture analyzer 530 indicates the gesture of the user for the specified virtual object. For example, in case analysis information indicating that the user taps the specified virtual object is received from the gesture analyzer 530, the intention to utter determination module 550 may determine that the received analysis information satisfies the specified condition.

In the intention to utter determination module 550, a method of determining the user's intention to utter may vary depending on the gesture of the user (or gesture type) received from the gesture analyzer 530. For example, the intention to utter determination module 550 may ask the user once more about the intention to utter and determine the intention to utter according to the response to the question in case analysis information indicating that the user is stroking the specified virtual object is received from the gesture analyzer 530.

The intention to utter determination module 550 may determine that the user has the intention to utter for a virtual object other than the specified virtual object in case a gesture for the other virtual object is received from the gesture analyzer 530. For example, the intention to utter determination module 550 may determine that the user has the intention to utter a voice command for a gallery application in case analysis information indicating that the user is holding a virtual object representing the gallery application is received from the gesture analyzer 530.

The intention to utter determination module 550 may determine that the specified condition is satisfied in case the analysis information received from the utterance start analyzer 540 indicates that the user starts uttering. The user may be referred to as the wearer of the external electronic device 402. The intention to utter determination module 550 may determine that the specified condition is not satisfied in case the analysis information received from the utterance start analyzer 540 indicates that another user other than the user starts uttering. The other user may be referred to as an outsider, or a person who is not the wearer of the external electronic device 402. The intention to utter determination module 550 may determine that the specified condition is not satisfied when the analysis information received from the utterance start analyzer 540 indicates that the sound input to the external electronic device 402 is noise.

The intention to utter determination module 550 may ask a question about the user's intention to utter and determine the intention to utter according to the response to the question in case the analysis information received from the gaze analyzer 510 indicates that the dwell time of the user's gaze toward a specified virtual object (e.g., the virtual object representing the voice recognition application) is equal to or longer than a specified time. The intention to utter determination module 550 may determine that the user has the intention to utter without asking about the user's intention to utter in case the analysis information received from the gaze analyzer 510 indicates that the dwell time of the user's gaze toward the specified virtual object representing the voice recognition application is equal to or longer than a specified time.

The intention to utter determination module 550 may more accurately determine the user's intention to utter a voice command based on the model constructed and trained by the learning module 560. The learning module 560 may train the model based on a machine learning algorithm using the analysis information received from the gaze analyzer 510, the face analyzer 520, the gesture analyzer 530, and the utterance start analyzer 540, and information on whether the user has actually uttered the voice command.

The execution module 570 may execute the voice recognition application in case it is determined that the user has the intention to utter a voice command through the intention to utter determination module 550 and control the voice recognition application to be in the state of being capable of receiving the user's voice command. For example, the execution module 570 may execute the voice recognition application and switch the voice recognition application to a listening mode.

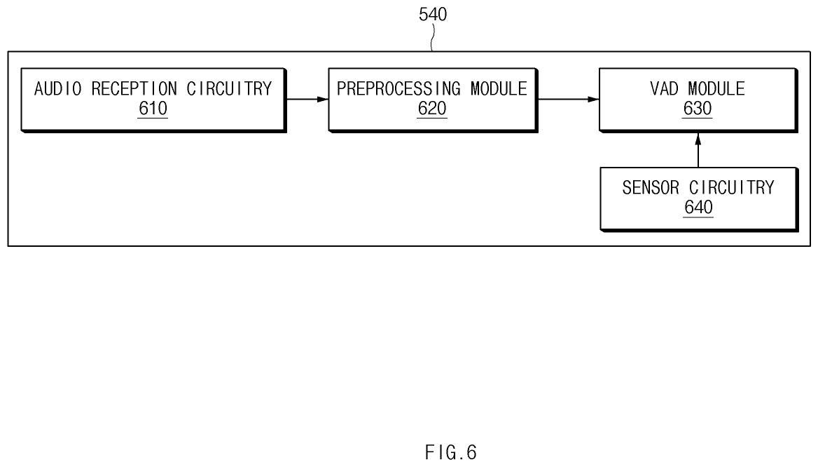

Hereinafter, the utterance start analyzer 540 will be described in more detail with reference to FIG. 6.

FIG. 6 is a block diagram of the utterance start analyzer according to an embodiment of the disclosure. The utterance start analyzer 540 shown in FIG. 6 may include a hardware module and a software module to determine the utterance start status of the user.

Referring to FIG. 6, in an embodiment of the disclosure, the utterance start analyzer 540 may include audio reception circuitry 610, a preprocessing module 620, a voice activity detection (VAD) module 630, and sensor circuitry 640. The audio reception circuit 610 may receive an audio signal coming from outside the external electronic device 402. In the disclosure, the audio reception circuitry 610 may be referred to as a microphone. The preprocessing module 620 may preprocess the audio signal received through the audio reception circuit 610. The non-preprocessed audio signal received through the audio reception circuitry 610 and the audio signal received through the audio reception circuitry 610 and preprocessed through the preprocessing module 620 may be transmitted to the VAD module 630. The sensor circuitry 640 may detect movement of the external electronic device 402. The sensor circuitry 640 may include, for example, a motion sensor, an acceleration sensor, and/or a gyro sensor. Movement of the device detected through the sensor circuitry 640 may be transmitted to the VAD module 630.

The VAD module 630 may determine an utterance start status of the user wearing the external electronic device 402 using the audio signal and device movement information. The VAD module 630 may detect a voice signal based on the band and magnitude of the audio signal. For example, the VAD module 630 may detect a voice signal from an audio signal of a specified magnitude or greater in the band of human voices. The VAD module 630 may detect movement of the device using the sensor circuitry 640 while the voice signal is detected. For example, the VAD module 630 may detect the wearer's utterance in case a specified movement is detected while the voice signal is detected. The specified movement may refer to the movement of the device due to the wearer's utterance. The specified movement may be detected by the sensor circuitry 640 in the form of movement or vibration. The VAD module 630 may acquire information on a start time and an end time of the utterance of the wearer based on the voice signal and the specified movement. The VAD module 630 may detect an outsider (a person other than the wearer)'s utterance in case the specified movement is not detected while the voice signal is detected.

According to an embodiment of the disclosure, the utterance start analyzer 540 may use different microphones in detecting the user's utterance or the outsider's utterance. For example, the external electronic device 402 may include an internal microphone and an external microphone. For example, the internal microphone may be disposed in a direction facing the wearer, and the external microphone may be disposed in a direction toward the outside of the wearer (e.g., a direction the wearer faces). The utterance start analyzer 540 may detect the outsider's utterance using the external microphone, and may detect the wearer's utterance using the internal microphone. The utterance start analyzer 540 may determine the utterance start status of the wearer based on the voice signal received through the internal microphone and the movement information about the device received through the sensor circuitry 640.

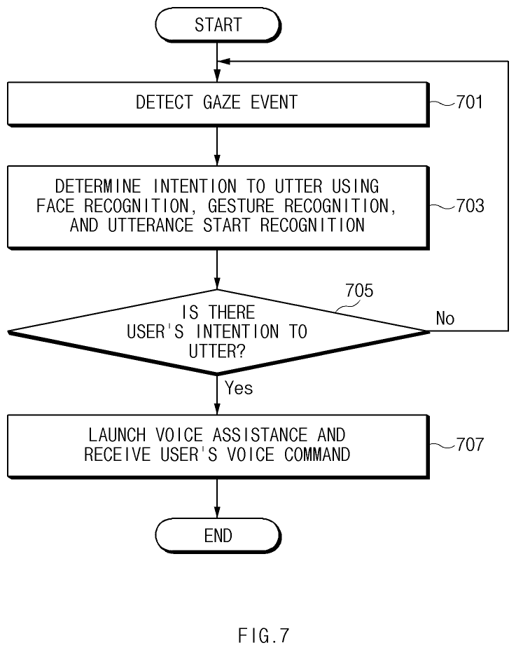

Hereinafter, operations of an electronic device according to an embodiment will be described with reference to FIG. 7.

FIG. 7 is a flowchart showing operations of an electronic device according to an embodiment of the disclosure. The operations shown in FIG. 7 may be performed by the electronic device 401 in FIG. 4 or the processor 430 in the electronic device 401.

In operation 701, the electronic device may detect a gaze event of a user. The gaze event may be that the user looks at a specified virtual object (e.g., a virtual object representing a voice recognition application). The electronic device may detect that the user looks at the specified virtual object through an external electronic device (e.g., the external electronic device 402 in FIG. 4) that is communicatively connected to the electronic device. The electronic device may detect that the user continuously looks at the specified virtual object for a specified time or longer through the external electronic device.

In operation 703, the electronic device may determine intention to utter using face recognition, gesture recognition, and utterance start recognition. The electronic device may recognize a face of the user, a gesture of the user, and utterance start corresponding to a point in time at which the gaze event is detected through the external electronic device. The electronic device may determine whether the user has the intention to utter based on information about the recognized the user's face, the user's gesture, and whether the user started utterance. The electronic device may determine that the user has the intention to utter a voice command in case at least one of pieces of information about the recognized the user's face, the user's gesture, and whether the user started utterance satisfies a specified condition. The specified condition may include that information about the recognized face of the user indicates a specified facial expression. For example, the electronic device may determine that the user has the intention to utter a voice command based on recognizing that the user opens his or her eyes wide. The specified condition may include that information on the recognized gesture of the user indicates a gesture for the virtual object representing the voice recognition application. For example, the electronic device may determine that the user has the intention to utter a voice command based on recognizing that the user taps the virtual object representing the voice recognition application. The specified condition may include that information on the recognized utterance start status of the user indicates that a wearer starts uttering. For example, the electronic device may determine that the wearer has the intention to utter a voice command based on recognizing that the wearer starts uttering.

For example, in operation 701, the electronic device may determine that the user has the intention to utter a voice command based on detecting that the user looks at the virtual object representing the voice recognition application for the specified time or longer. As the electronic device performs operation 701, the above-described operation 703 may include an operation of determining that the user has the intention to utter a voice command based on detecting that the user continuously looks at the specified virtual object for the specified time and or longer and at least one of pieces of information about the user's face, the user's gesture, and whether the user started utterance satisfying the specified condition. For another example, in case the electronic device detects that the user looks at the virtual object representing the voice recognition application for the specified time or longer, the electronic device may determine that the user has the intention to utter a voice command regardless of whether at least one of pieces of information about the user's face, the user's gesture, and whether the user started utterance satisfies the specified condition.

In operation 705, the electronic device may determine whether there is the user's intention to utter. In case it is determined in operation 703 that the user has the intention to utter a voice command, the electronic device may perform operation 707. In case it is determined in operation 703 that the user has no intention to utter a voice command, the electronic device may wait until detecting a next gaze event.

In operation 707, the electronic device may launch a voice assistant and receive a voice command from the user. A voice assistant may be referred to as a voice recognition application providing voice recognition services. For example, the electronic device may launch the voice assistant by executing the voice recognition application. The electronic device may control the voice recognition application to be in the state of being capable of receiving the voice command by switching the voice recognition application to a listening mode. The electronic device may receive voice commands through the external electronic device in the listening mode.

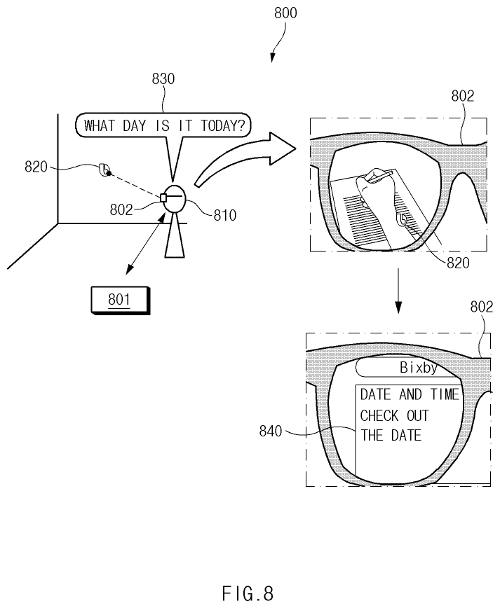

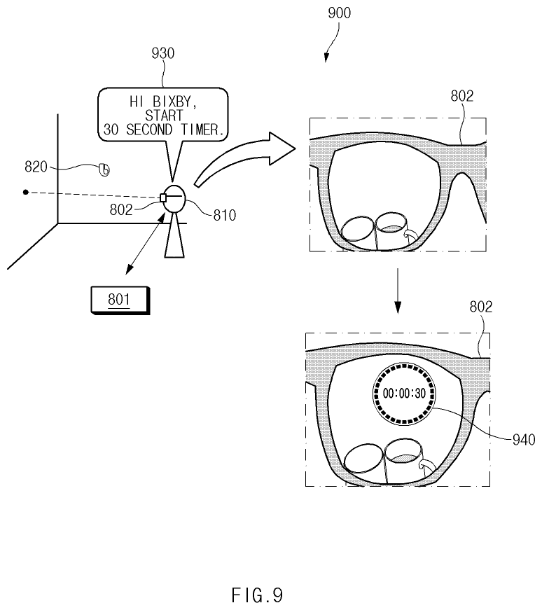

Hereinafter, a user interface provided by an electronic device according to an embodiment will be described with reference to FIGS. 8 and 9. An electronic device 801 shown in FIGS. 8 and 9 may be the electronic device 401 in FIG. 4. An external electronic device 802 shown in FIGS. 8 and 9 may be the external electronic device 402 in FIG. 4.

FIG. 8 is a diagram 800 illustrating a user interface provided by an electronic device according to an embodiment of the disclosure.

Referring to FIG. 8, a user 810 wearing an external electronic device 802 may look at a virtual object 820 representing a voice recognition application. The virtual object 820 may be, for example, an icon, a character image, or an avatar representing the voice recognition application. The electronic device 801 may receive information indicating that it detects a gaze of the user looking at the virtual object 820 from the external electronic device 802. The electronic device 801 may receive information in which the user's gaze is analyzed. The electronic device 801 may receive, from the external electronic device 802, information from analysis of the user's face, the user's gesture or analysis of whether the user started utterance, corresponding to a point in time at which the user's gaze on the virtual object 820 is detected. For example, the electronic device 801 may execute the voice recognition application of the electronic device 801 based on the fact that at least one of the information from analysis of the user's gaze and the information from analysis of the user' face, the user's gesture or analysis of whether the user started utterance in the received analyzed information satisfies the specified condition, and may control the voice recognition application to be in the state of being capable of receiving a voice command. For another example, the electronic device 801 may execute the voice recognition application in case the information from analysis of the user's gaze satisfies the specified condition (e.g., the dwell time of the user's gaze on the virtual object 820 will be equal to or longer than a specified time), and may control the voice recognition application to be in the state of being capable of receiving a voice command. After executing the voice recognition application based on the user's gaze, the electronic device 801 may determine whether to provide a response corresponding to a received user's voice command based on the information from analysis of the user's face, gesture or analysis of whether the user started utterance.

For example, the user 810 may utter in a state of looking at the virtual object 820. The electronic device 801 may receive, from the external electronic device 802, a voice input corresponding to a user utterance 830 in the state of looking at the virtual object 820. The user utterance 830 may not include a wake-up word (e.g., “Hi Bixby”), but include only a command (e.g., “What day is today?”). For another example, the user 810 may utter in a state of looking at a different point after looking at the virtual object 820 for a specified time (e.g., N seconds) or longer. As described above, the electronic device 801 may execute the voice recognition application in case the dwell time of the user's gaze on the virtual object 820 is equal to or longer than the specified time and control the voice recognition application to be in the state of being capable of receiving a voice command, and may execute a voice command corresponding to the user utterance 830 that does not include the wake-up word received from the external electronic device 802.

The electronic device 801 may provide a result of executing a command corresponding to the user utterance 830 (e.g., a user interface 840) through the external electronic device 802. For example, the electronic device 801 may display the user interface 840 including date information on a display of the external electronic device 802 (e.g., the display 440 in FIG. 4).

FIG. 9 is a diagram 900 illustrating the user interface provided by the electronic device according to an embodiment of the disclosure.

Referring to FIG. 9, the user 810 wearing the external electronic device 802 may look somewhere else without looking at the virtual object 820 representing the voice recognition application. For example, the user 810 may utter in a state of not looking at the virtual object 820. The electronic device 801 may receive, from the external electronic device 802, a voice input corresponding to a user utterance 930 in the state of not looking at the virtual object 820. The user utterance 930 may include a wake-up word (e.g., “Hi Bixby”). The electronic device 801 may execute a voice recognition application based on recognition of the wake-up word included in the user utterance 930 and control the voice recognition application to be in a state of being capable of receiving a voice command.

The electronic device 801 may execute a command corresponding to the user utterance received after the wake-up word. The user utterance 930 may include a command (e.g., “Start a 30 second timer.”) after the wake-up word. The electronic device 801 may provide a result of executing a command corresponding to the user utterance 930 (e.g., a user interface 940) through the external electronic device 802. For example, the electronic device 801 may display the user interface 940 of a timer application on the display of the external electronic device 802 (e.g., the display 440 in FIG. 4).

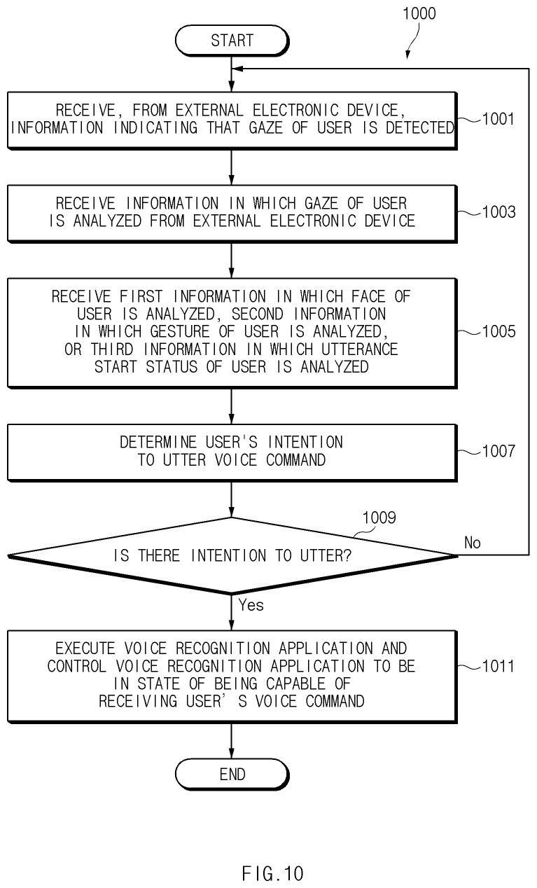

Hereinafter, operations of an electronic device according to an embodiment will be described with reference to FIG. 10.

FIG. 10 is a flowchart 1000 showing operations of an electronic device according to an embodiment of the disclosure. Operations of the electronic device described below may be performed by the electronic device 401 in FIG. 4 or the processor 430 of the electronic device 401. Operations of an external electronic device described below may be performed by the external electronic device 402 of FIG. 4 or the processor 490 of the external electronic device 402.

In operation 1001, the electronic device may receive, from an external electronic device, information indicating that a user's gaze is detected. The electronic device may receive information indicating that the user's gaze on a specified object displayed on a display of the external electronic device (e.g., the display 440 in FIG. 4) is detected from the external electronic device through a communication circuitry (e.g., the communication circuitry 410 in FIG. 4). The external electronic device may be wearable on at least part of the user's body. The specified object may be a virtual object representing a voice recognition application.

In operation 1003, the electronic device may receive information from analysis of the user's gaze from the external electronic device. The information from analysis of the user's gaze may be acquired using information input to a camera (e.g., the camera 450 in FIG. 4) and/or a sensor (e.g., the sensor 460 in FIG. 4) of the external electronic device. For example, the information from analysis of the user's gaze may include information on a direction corresponding to the user's gaze and/or the dwell time of the user's gaze.

In operation 1005, the electronic device may receive, from the external electronic device, first information from analysis of the user's face, second information from analysis of the user's gesture, or third information from analysis of whether the user started utterance. The electronic device may receive, from the external electronic device, the first information, the second information, or the third information corresponding to a point in time at which the user's gaze is detected. The first information, the second information, and the third information may include information analyzed based on information input to the external electronic device within a specified time from the point in time at which the user's gaze is detected. For example, the first information may be information from analysis of the user's face using information input to a camera (e.g., the camera 450 in FIG. 4) and/or a sensor (e.g., the sensor 460 in FIG. 4) based on eye tracking and head tracking technology, by the external electronic device. For example, the second information may be information from analysis of the user's gesture using information input to the camera based on hand tracking technology, by the external electronic device. For example, the third information may be information from analysis of whether the wearer of the external electronic device started utterance based on an audio signal received through a microphone and movement information detected through the sensor, by the external electronic device.

In operation 1007, the electronic device may determine the user's intention to utter a voice command. The electronic device may determine the user's intention to utter a voice command based on whether at least one of the first information, the second information, or the third information, and the information from analysis of the user's gaze satisfy a specified condition. The electronic device may determine that the information from analysis of the user's gaze satisfies the specified condition in case the information from analysis of the user's gaze indicates that the dwell time of the user's gaze on a specified virtual object is equal to or longer than a specified time. In case the first information indicates a specified facial expression, the electronic device may determine that the first information satisfies the specified condition. The specified facial expression may be a facial expression learned as a facial expression with the intention to utter by a machine learning algorithm or a facial expression preset by the user as a facial expression with the intention to utter. The specified facial expression may include, for example, widening the eyes, frowning, or slightly lifting the head.

In case the second information indicates a gesture for the specified virtual object, the electronic device may determine that the second information satisfies the specified condition. The gesture for the specified virtual object may include, for example, touching, tapping, stroking, or holding the specified virtual object.

In case the second information indicates a first gesture for the specified virtual object, the electronic device may determine that the user has the intention to utter a voice command. The electronic device may transmit a request to ask about the intention to utter to the external electronic device and determine the user's intention to utter according to a response received from the external electronic device in case the second information indicates a second gesture for the specified virtual object. The first gesture is a gesture that is set such that the electronic device determines that the user has the intention to utter without asking additional questions. The second gesture is a gesture that is set such that the electronic device asks the user one more question and then determines the intention to utter based on the response to the question. The first gesture may be a gesture in which the user's intention to call the voice recognition application represented by the specified virtual object is clear. For example, the first gesture may be a gesture of tapping the specified virtual object. The second gesture may be a gesture in which the user's intention to call the voice recognition application represented by the specified virtual object is unclear. For example, the second gesture may be a gesture of stroking the specified virtual object. The first gesture may be a gesture learned as a gesture with a clear intention to utter by a machine learning algorithm, or a gesture preset by the user as a gesture with a clear intention to utter. The second gesture may be a gesture other than the learned gesture or the preset gesture.

In case the third information indicates that the user starts uttering, the electronic device may determine that the third information satisfies the specified condition. Herein, the user may be a user wearing the external electronic device. In case the third information indicates that a user (e.g., an outsider) other than the user wearing the external electronic device starts uttering, the electronic device may determine that the third information does not satisfy the specified condition. The electronic device may determine that the third information does not satisfy the specified condition in case the third information indicates that the sound input to the external electronic device is noise. For example, noise may include an audio signal that are not in a specified band (e.g., the band of human voices), or an audio signal smaller than a specified magnitude even if it is in the specified band.

In operation 1009, the electronic device may determine whether there is the intention to utter. The electronic device may determine that the user has the intention to utter a voice command in case at least one of the first information, the second information, or the third information, and the information from analysis of the user's gaze satisfy the specified condition. For example, the electronic device determines that the user has the intention to utter a voice command in case the information in which the gaze of the user is analyzed satisfies the specified condition and the first information, second information, or third information satisfies the specified condition. The electronic device may determine that the user has the intention to utter a voice command when the information from analysis of the user's gaze indicates that the dwell time of the user's gaze on the specified virtual object is equal to or longer than a specified time and the first information indicates the specified facial expression. The electronic device may determine that the user has the intention to utter a voice command in case the information from analysis of the user's gaze indicates that the dwell time of the user's gaze on the specified virtual object is equal to or longer than a specified time or and the second information indicates the gesture for the virtual object. The electronic device may determine that the user has the intention to utter a voice command in case the information from analysis of the user's gaze indicates that the dwell time of the user's gaze on the specified virtual object is equal to or longer than a specified time and the third information indicates the user starts uttering. The electronic device may perform operation 1011 in case it is determined that the user has the intention to utter a voice command.

For example, the electronic device may determine that the user has no intention to utter a voice command in case the information from analysis of the user's gaze does not satisfy the specified condition, or in case the first information, the second information, and the third information do not satisfy the specified condition even if the information from analysis of the user's gaze satisfies the specified condition. In this case, the electronic device may wait until the next gaze detection information is received from the external electronic device.

In operation 1011, the electronic device may execute the voice recognition application and control the voice recognition application to be in a state of being capable of receiving the user's voice command. As it is determined that the user has the intention to utter a voice command, the electronic device may execute the voice recognition application stored in the memory (e.g., the memory 420 in FIG. 4) and control the voice recognition application to be in a state of being capable of receiving the user's voice command. The state of being capable of receiving a voice command of the user may be referred to as the “listening mode.”

The electronic device may receive audio data corresponding to a user's voice input from the external electronic device through the communication circuitry. For example, the electronic device may receive audio data corresponding to the user's voice input through an external electronic device (or a microphone of the external electronic device (e.g., the microphone 470 in FIG. 4)) in the listening mode. The voice input may not include a wake-up word. For example, the voice input may include only commands. The electronic device may execute a command corresponding to the voice input through the voice recognition application. The electronic device may execute the command corresponding to the voice input by converting audio data corresponding to the voice input into text data directly or through an external server, using the text data to acquire information about the user's intention and/or one or more actions, and executing one or more actions based on the acquired information.

The electronic device may provide an execution result of the command corresponding to the voice input to the user through the external electronic device. For example, the electronic device may transmit the execution result of the command corresponding to the voice input to the external electronic device through the communication circuitry to allow the execution result to be displayed on the display of the external electronic device.

According to an embodiment of the disclosure, an electronic device (e.g., the electronic device 101 in FIG. 1, the electronic device 401 in FIGS. 4 and 5, or the electronic device 801 in FIGS. 8 and 9) may include a communication circuitry (e.g., the communication module 190 in FIG. 1 or the communication circuitry 410 in FIG. 4), memory (e.g., the memory 130 in FIG. 1 or the memory 420 in FIG. 4), and a processor (e.g., the processor 120 in FIG. 1 or the processor 430 in FIG. 4) operatively connected to the communication circuitry and the memory, and the memory may store one or more instructions, when executed by the processor, cause the electronic device to receive information indicating detection of the user's gaze on a specified virtual object displayed on a display (e.g., the display module 160 in FIG. 1, the display 261-1 and/or 261-2 in FIG. 2, or the display 440 in FIG. 4) of an external electronic device (e.g., the external electronic device 102 or the external electronic device 104 in FIG. 1, the electronic device 201 in FIG. 2, the external electronic device 402 in FIGS. 4 and 5, or the external electronic device 802 in FIGS. 8 and 9) wearable on at least part of a user's body from the external electronic device through the communication circuitry, receive information from analysis of the user's gaze, receive, from the external electronic device, first information from analysis of the user's face, second information from analysis of the user's gesture, or third information from analysis of whether the user started utterance, corresponding to a point in time at which the user's gaze is detected, determine a user's intention to utter a voice command based on whether at least one of the first information, the second information, or the third information, and the information from analysis of the user' gaze satisfy a specified condition, and execute a voice recognition application stored in the memory upon determining that there is the intention to utter and control the voice recognition application to be in a state of being capable of receiving a voice command of the user.

According to an embodiment of the disclosure, the instructions, when executed by the processor, may cause the electronic device to receive audio data corresponding to a user's voice input from the external electronic device through the communication circuitry and execute a command corresponding to the voice input through the voice recognition application, and the voice input may not include a wake-up word.

According to an embodiment of the disclosure, the instructions, when executed by the processor, may cause the electronic device to determine that there is the intention to utter in case the information from analysis of the user's gaze indicates that the dwell time of the user's gaze on the specified virtual object is equal to or longer than a specified time and the first information indicates a specified facial expression.

According to an embodiment of the disclosure, the instructions, when executed by the processor, may cause the electronic device to determine that there is the intention to utter in case the information from analysis of the user's gaze indicates that the dwell time of the user's gaze on the specified virtual object is equal to or longer than a specified time and the second information indicates a gesture for the virtual object.

According to an embodiment of the disclosure, the instructions, when executed by the processor, may cause the electronic device to determine that there is the intention to utter in case the information from analysis of the user's gaze indicates that the dwell time of the user's gaze on the specified virtual object is equal to or longer than a specified time and the third information indicates that the user starts uttering.

According to an embodiment of the disclosure, the instructions, when executed by the processor, may cause the electronic device to determine that there is the intention to utter in case the second information indicates a first gesture for the specified virtual object, and transmit a request to ask about the intention to utter to the external electronic device and determine the intention to utter according to a response received from the external electronic device in case the second information indicates a second gesture for the specified virtual object.

According to an embodiment of the disclosure, the instructions, when executed by the processor, may cause the electronic device to determine that the third information does not satisfy the specified condition in case the third information indicates that a user other than the user starts uttering, or that sound input to the external electronic device is noise.

According to an embodiment of the disclosure, the first information, the second information, and the third information may include information analyzed based on information input within a specified time from a point in time at which the user's gaze is detected.

According to an embodiment of the disclosure, the instructions, when executed by the processor, may cause the electronic device to provide a hint for the voice command based on context information related to the user through the voice recognition application, and the context information may include at least one of a usage history of the user for the voice recognition application or the gesture of the user.

According to an embodiment of the disclosure, the instructions, when executed by the processor, may cause the electronic device to provide a command to execute at least one function as the hint in a natural language form based on the gesture of the user toward a virtual object representing an application supporting the at least one function.

According to an embodiment of the disclosure, the instructions, when executed by the processor, may cause the electronic device to transmit a request to ask about the intention to utter to the external electronic device and determine the intention to utter according to a response received from the external electronic device in case information from analysis of the user's gaze indicates that the dwell time of the user's gaze on the specified virtual object is equal to or longer than the specified time.

According to an embodiment of the disclosure, the instructions, when executed by the processor, may cause the electronic device to construct and train an intention to utter determination model using analysis information including the first information, the second information, and the third information and information on whether the voice recognition application is actually used.

According to an embodiment of the disclosure, a method of operating an electronic device (e.g., the electronic device 101 in FIG. 1, the electronic device 401 in FIGS. 4 and 5, or the electronic device 801 in FIGS. 8 and 9) may include receiving information indicating detection of user's gaze on a specified virtual object displayed on a display (e.g., the display module 160 in FIG. 1, the display 261-1 and/or 261-2 in FIG. 2, or the display 440 in FIG. 4) of an external electronic device (e.g., the external electronic device 102 or the external electronic device 104 in FIG. 1, the electronic device 201 in FIG. 2, the external electronic device 402 in FIGS. 4 and 5, or the external electronic device 802 in FIGS. 8 and 9) wearable on at least part of a user's body from the external electronic device through a communication circuitry (e.g., the communication module 190 in FIG. 1 or the communication circuitry 410 in FIG. 4), receiving information from analysis of the user's gaze, receiving, from the external electronic device, first information from analysis of the user's face, second information from analysis of the user' gesture, or third information from analysis of whether the user started utterance, corresponding to a point in time at which the user's gaze is detected, determining a user's intention to utter a voice command based on whether at least one of the first information, the second information, or the third information, and the information from analysis of the user's gaze satisfy a specified condition, and executing a voice recognition application stored in the memory (e.g., the memory 130 in FIG. 1 or the memory 420 in FIG. 4) upon determining that there is the intention to utter and controlling the voice recognition application to be in a state of being capable of receiving a voice command of the user.

According to an embodiment of the disclosure, in the method, audio data corresponding to a user's voice input may be received from the external electronic device through the communication circuitry, a command corresponding to the voice input may be executed through the voice recognition application, and the voice input may not include a wake-up word.

According to an embodiment of the disclosure, in the method, it may be determined that there is the intention to utter in case the information from analysis of the user's gaze indicates that the dwell time of the user's gaze on the specified virtual object is equal to or longer than a specified time and the first information indicates a specified facial expression.

According to an embodiment of the disclosure, in the method, it may be determined that there is the intention to utter in case the information from analysis of the user's gaze indicates that the dwell time of the user's gaze on the specified virtual object is equal to or longer than a specified time and the second information indicates a gesture for the virtual object.

According to an embodiment of the disclosure, in the method, it may be determined that there is the intention to utter in case the information from analysis of the user's gaze indicates that the dwell time of the user's gaze on the specified virtual object is equal to or longer than a specified time and the third information indicates that the user starts uttering.

According to an embodiment of the disclosure, in the method, it may be determined that there is the intention to utter in case the second information indicates a first gesture for the specified virtual object, a request to ask about the intention to utter may be transmitted to the external electronic device in case the second information indicates a second gesture for the specified virtual object, and the intention to utter may be determined according to a response received from the external electronic device.

According to an embodiment of the disclosure, in the method, it may be determined that the third information does not satisfy the specified condition in case the third information indicates that a user other than the user starts uttering, or that sound input to the external electronic device is noise.

According to an embodiment of the disclosure, the first information, the second information, and the third information may include information analyzed based on information input within a specified time from a point in time at which the user's gaze is detected.

According to an embodiment of the disclosure, in the method, a hint for the voice command may be provided based on context information related to the user through the voice recognition application, and the context information may include at least one of a usage history of the user for the voice recognition application or the gesture of the user.

According to an embodiment of the disclosure, in the method, a command to execute at least one function may be provided as the hint in a natural language form based on the gesture of the user toward a virtual object representing an application supporting the at least one function.

According to an embodiment of the disclosure, in the method, a request to ask about the intention to utter may be transmitted to the external electronic device in case information indicating that the dwell time of the user's gaze toward the specified virtual object is equal to or longer than the specified time is received from the external electronic device, and the intention to utter may be determined according to a response received from the external electronic device.

According to an embodiment of the disclosure, in the method, an intention to utter determination model may be constructed and trained using analysis information including the first information, the second information, and the third information and information on whether the voice recognition application is actually used.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory, such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
communication circuitry;
memory storing one or more computer programs; and
one or more processors communicatively coupled to the communication circuitry and the memory,
wherein the one or more computer programs include computer-executable instructions that, when executed by the one or more processors individually or collectively, cause the electronic device to:
receive, from an external electronic device, information indicating detection of user's gaze on a specified virtual object displayed on a display of the external electronic device wearable on at least part of a user's body through the communication circuitry,
receive information from analysis of the user's gaze,
receive, from the external electronic device, first information from analysis of the user's face, second information from analysis of the user' gesture, or third information from analysis of whether the user started utterance, corresponding to a point in time at which the user's gaze is detected,
determine a user's intention to utter a voice command based on whether at least one of the first information, the second information, or the third information, and the information from analysis of the user's gaze satisfy a specified condition, and
execute a voice recognition application stored in the memory upon determining that there is the intention to utter and control the voice recognition application to be in a state of being capable of receiving a voice command of the user.

2. The electronic device of claim 1,
wherein the one or more computer programs further include computer-executable instructions that, when executed by the one or more processors individually or collectively, cause the electronic device to:
receive audio data corresponding to a user's voice input from the external electronic device through the communication circuitry, and
execute a command corresponding to the voice input through the voice recognition application, and
wherein the voice input does not include a wake-up word.

3. The electronic device of claim 1,
wherein the one or more computer programs further include computer-executable instructions that, when executed by the one or more processors individually or collectively, cause the electronic device to determine that there is the intention to utter in case the information from analysis of the user's gaze indicates that a dwell time of the user's gaze on the specified virtual object is equal to or longer than a specified time, and
wherein the first information indicates a specified facial expression.

4. The electronic device of claim 1,
wherein the one or more computer programs further include computer-executable instructions that, when executed by the one or more processors individually or collectively, cause the electronic device to determine that there is the intention to utter in case the information from analysis of the user's gaze indicates that a dwell time of the user's gaze on the specified virtual object is equal to or longer than a specified time, and
wherein the second information indicates a gesture for the specified virtual object.

5. The electronic device of claim 1,
wherein the one or more computer programs further include computer-executable instructions that, when executed by the one or more processors individually or collectively, cause the electronic device to determine that there is the intention to utter in case the information from analysis of the user's gaze indicates that a dwell time of the user's gaze on the specified virtual object is equal to or longer than a specified time, and
wherein the third information indicates that the user starts uttering.

6. The electronic device of claim 4, wherein the one or more computer programs further include computer-executable instructions that, when executed by the one or more processors individually or collectively, cause the electronic device to:
determine that there is the intention to utter in case the second information indicates a first gesture for the specified virtual object;
transmit a request to ask about the intention to utter to the external electronic device; and
determine the intention to utter according to a response received from the external electronic device in case the second information indicates a second gesture for the specified virtual object.

7. The electronic device of claim 5, wherein the one or more computer programs further include computer-executable instructions that, when executed by the one or more processors individually or collectively, cause the electronic device to determine that the third information does not satisfy the specified condition in case the third information indicates that a user other than the user starts uttering, or that sound input to the external electronic device is noise.

8. The electronic device of claim 1, wherein the first information, the second information, and the third information include analyzed information based on inputted information within a specified time from a point in time at which user's gaze is detected.

9. The electronic device of claim 1,
wherein the one or more computer programs further include computer-executable instructions that, when executed by the one or more processors individually or collectively, cause the electronic device to provide a hint for the voice command based on context information related to the user through the voice recognition application, and
wherein the context information includes at least one of a usage history of the user for the voice recognition application or the user's gesture.

10. The electronic device of claim 9, wherein the one or more computer programs further include computer-executable instructions that, when executed by the one or more processors individually or collectively, cause the electronic device to provide a command to execute at least one function as the hint in a natural language form based on the user's gesture toward a virtual object representing an application supporting the at least one function.

11. The electronic device of claim 1, wherein the one or more computer programs further include computer-executable instructions that, when executed by the one or more processors individually or collectively, cause the electronic device to:
transmit a request to ask about the intention to utter to the external electronic device; and
determine the intention to utter according to a response received from the external electronic device, in case the information from analysis of the user's gaze indicates that a dwell time of the user's gaze on the specified virtual object is equal to or longer than the specified time.

12. The electronic device of claim 1, wherein the one or more computer programs further include computer-executable instructions that, when executed by the one or more processors individually or collectively, cause the electronic device to construct and train an intention to utter determination model using analysis information including the first information, the second information, and the third information and information on whether the voice recognition application is actually used.

13. A method of operating an electronic device, the method comprising:
receiving from an external electronic device information indicating detection of a user's gaze on a specified virtual object displayed on a display of an external electronic device wearable on at least part of a user's body through communication circuitry;
receiving information from analysis of the user's gaze;
receiving, from the external electronic device, first information from analysis of the user's face, second information from analysis of the user' gesture, or third information from analysis of whether the user started utterance, corresponding to a point in time at which the user's gaze is detected;
determining a user's intention to utter a voice command based on whether at least one of the first information, the second information, or the third information, and the information from analysis of the user's gaze satisfy a specified condition; and
executing a voice recognition application stored in memory upon determining that there is the intention to utter and controlling the voice recognition application to be in a state of being capable of receiving a voice command of the user.

14. The method of claim 13,
wherein audio data corresponding to a user's voice input is received from the external electronic device through the communication circuitry,
wherein a command corresponding to the voice input is executed through the voice recognition application, and
wherein the voice input does not include a wake-up word.

15. The method of claim 13, wherein an intention to utter determination model is constructed and trained using analysis information including the first information, the second information, and the third information and information on whether the voice recognition application is actually used.

16. The method of claim 13, further comprising:
determining that there is the intention to utter in case the information from analysis of the user's gaze indicates that a dwell time of the user's gaze on the specified virtual object is equal to or longer than a specified time,
wherein the first information indicates a specified facial expression.

17. The method of claim 13, further comprising:
determining that there is the intention to utter in case the information from analysis of the user's gaze indicates that a dwell time of the user's gaze on the specified virtual object is equal to or longer than a specified time,
wherein the second information indicates a gesture for the specified virtual object.

18. The method of claim 13, further comprising:
determining that there is the intention to utter in case the information from analysis of the user's gaze indicates that a dwell time of the user's gaze on the specified virtual object is equal to or longer than a specified time,
wherein the third information indicates that the user starts uttering.

19. One or more non-transitory computer-readable storage media storing computer-executable instructions that, when executed by one or more processors of an electronic device, cause the electronic device to perform operations, the operations comprising:
receiving from an external electronic device information indicating detection of a user's gaze on a specified virtual object displayed on a display of the external electronic device wearable on at least part of a user's body through a communication circuitry;
receiving information from analysis of the user's gaze;
receiving, from the external electronic device, first information from analysis of the user's face, second information from analysis of a user' gesture, or third information from analysis of whether the user started utterance, corresponding to a point in time at which the user's gaze is detected;
determining a user's intention to utter a voice command based on whether at least one of the first information, the second information, or the third information, and the information from analysis of the user's gaze satisfy a specified condition; and
executing a voice recognition application stored in memory upon determining that there is the intention to utter and controlling the voice recognition application to be in a state of being capable of receiving a voice command of the user.

20. The one or more non-transitory computer-readable storage media of claim 19,
wherein audio data corresponding to a user's voice input is received from the external electronic device through the communication circuitry,
wherein a command corresponding to the voice input is executed through the voice recognition application, and
wherein the voice input does not include a wake-up word.
